(19) United States
(12) Patent Application Publication
(10) Pub. No.: US 2013/0033538 A1
(43) Pub. Date: Feb. 7, 2013

(54) IMAGE RECORDING APPARATUS AND NONTRANSITORY STORAGE MEDIUM STORING PROGRAM

(71) Applicant: Katsuaki SUZUKI, Gifu-shi (JP)

(72) Inventor: Katsuaki SUZUKI, Gifu-shi (JP)

(73) Assignee: BROTHER KOGYO KABUSHIKI KAISHA, Nagoya-shi (JP)

(21) Appl. No.: 13/565,580

(22) Filed: Aug. 2, 2012

(30) Foreign Application Priority Data
Aug. 3, 2011 (JP) 2011-170057

(51) Int. Cl. B41J 29/393

(52) U.S. Cl. 347/19

(57) ABSTRACT

An image recording apparatus, including: a first head for ejecting first liquid; a second head for ejecting second liquid; a second-liquid test-pattern recording command section configured to command recording of a test pattern of the second liquid on the recording medium; and an output controller configured to output recording data to the first bead and/or the second head. When the second-liquid test-pattern recording command section does not command the recording of the test pattern of the second liquid, the output controller outputs recording data representative of an image to be recorded, to the first head and the second head. When the second-liquid test-pattern recording command section commands the recording of the test pattern of the second liquid, the output controller outputs the recording data representative of the test pattern of the second liquid, not to the first head but to the second head.

### CROSS REFERENCE TO RELATED APPLICATION

The present application claims priority from Japanese Patent Application No. 2011-170057, which was filed on Aug. 3, 2011, the disclosure of which is herein incorporated by reference in its entirety.

### BACKGROUND OF THE INVENTION

1. Field of the Invention

The present invention relates to an image recording apparatus configured to eject, onto a recording medium, second liquid for coagulating or precipitating a constituent of first liquid before the first liquid is ejected, and relates to a nontransitory storage medium storing a program to be executed by a computer of the inane recording apparatus.

2. Description of the Related Art

There is known a printer configured to eject pretreatment liquid (second liquid) for coagulating or precipitating a coloring agent of ink (first liquid) in order to reduce spreading of the ink formed on a sheet. In such a printer, the pretreatment liquid is ejected, before the ink is ejected, onto areas on each of which a dot is to be formed.

### SUMMARY OF THE INVENTION

From a viewpoint of reducing consumption of the pretreatment liquid, the pretreatment liquid is preferably applied only to areas on each of which an ink dot is to be formed. In some printers, a control circuit is configured to execute an ejection control using image data for an image to be recorded, such that the ink and the pretreatment liquid are ejected onto the same positions. In this configuration, it is possible to consider that the printer is configured such that the pretreatment liquid is not applied in the recording depending upon needs of a user. However, since the pretreatment liquid is transparent, it has not been assumed that recording is performed by ejecting only the pretreatment liquid without ejecting the ink. However, an inventor of the present invention has found that, when a test pattern is recorded for adjusting a pretreatment-liquid head, the pretreatment-liquid head can be suitably adjusted by the test pattern using only the pretreatment liquid.

This invention has been developed to provide an image recording apparatus and a nontransitory storage medium storing a program to be executed by a computer of the image recording apparatus capable of recording a test pattern of only second liquid which does not overlap first liquid in a configuration in which ejections of the first liquid and the second liquid are controlled based on the same image data.

The present invention provides an image recording apparatus, comprising: a conveyor mechanism configured to convey a recording medium in a conveying direction; a first-liquid ejection head having at least one first ejection opening, the first-liquid ejection head configured to eject first liquid for recording an image on the recording medium through the first ejection opening; a second-liquid ejection head having at least one second ejection opening, the second-liquid ejection head configured to eject transparent liquid as second liquid through the second ejection opening; a recording-data storage device configured to store therein recording data representative of one of an image to be recorded and an image of a test pattern of the second liquid; a second-liquid test-pattern recording command section configured to command recording of the test pattern of the second liquid on the recording medium; and an output controller configured to output the recording data selectively to at least one of the first-liquid ejection head and the second-liquid ejection head, the output controller configured to: output the recording data representative of the image to be recorded, to the first-liquid ejection head and the second-liquid ejection head when the second-liquid test-pattern recording command section does not command the recording of the test pattern of the second liquid; and output the recording data representative of the test pattern of the second liquid, not to the first-liquid ejection head but to the second-liquid ejection head when the second-liquid test-pattern recording command section commands the recording of the test pattern of the second liquid.

The present invention provides an image recording apparatus, comprising: a conveyor mechanism configured to convey a recording medium in a conveying direction; a first-liquid ejection head having at least one first ejection opening, the first-liquid ejection head configured to eject first liquid for recording an image on the recording medium through the first ejection opening; a second-liquid ejection head having at least one second ejection opening, the second-liquid ejection head configured to eject transparent liquid as second liquid through the second ejection opening; a recording-data storage device configured to store therein recording data representative of one of an image to be recorded and an image of a test pattern of the second liquid; and an output controller configured to output the recording data selectively to at least one of the first-liquid ejection head and the second-liquid ejection head, wherein the recording data representative of the image to be recorded corresponds to an image recording command that is a command for recording the image to be recorded, on the recording medium, and wherein the recording data representative of the image of the test pattern of the second liquid corresponds to a test-pattern recording command that is a command for recording the image of the test pattern of the second liquid on the recording medium, the output controller configured to: output the recording data representative of the image to be recorded, to the first-liquid ejection head and the second-liquid ejection head when the image recording command is outputted; and output the recording data representative of the test pattern of the second liquid, not to the first-liquid ejection head but to the second-liquid ejection head when the test-pattern recording command is outputted.

The present invention provides a nontransitory storage medium storing a program to be executed by a computer of an image recording apparatus, the image recording apparatus comprising: a conveyor mechanism configured to convey a recording medium in a conveying direction; a first-liquid ejection head having at least one first ejection opening, the first-liquid ejection head configured to eject first liquid for recording an image on the recording medium through the first ejection opening; a second-liquid ejection head having at least one second ejection opening, the second-liquid ejection head configured to eject transparent liquid as second liquid through the second ejection opening; and a recording-data storage device configured to store therein recording data representative of one of an image to be recorded and an image of a test pattern of the second liquid, the program designed to have the computer function as: a second-liquid test-pattern recording command section configured to command recording of the test pattern of the second liquid on the recording medium; and an output controller configured to output the recording data selectively to at least one of the first-liquid ejection head and the second-liquid ejection head, the output controller configured to: output the recording data representative of the image to be recorded, to the first-liquid ejection head and the second-liquid ejection head when the second-liquid test-pattern recording command section does not command the recording of the test pattern of the second liquid; and output the recording data representative of the test pattern of the second liquid, not to the first-liquid ejection head but to the second-liquid ejection head when the second-liquid test-pattern recording command section commands the recording of the test pattern of the second liquid.

According to the present invention, when the test pattern of the second liquid is recorded on the recording medium in a configuration in which common recording data is supplied selectively to at least one of the first and second-liquid ejection heads, the recording data representative of the test pattern of the second liquid is outputted only to the second-liquid ejection head, making it possible to record the test pattern of only the second liquid which does not overlap the first liquid,

### BRIEF DESCRIPTION OF THE DRAWINGS

The objects, features, advantages, and technical and industrial significance of the present invention will be better understood by reading the following detailed description of the embodiments of the invention, when considered in connection with the accompanying drawings, in which:

FIG. 1 is a side view generally showing an ink-jet printer as a first embodiment of the present invention;

FIG. 2 is a functional block diagram of a controller shown in FIG. 1;

FIG. 3A is a flow-chart showing a print operation performed by the ink-jet printer shown in FIG. 1, and FIG. 3B is a flow-chart showing a print operation for recording a test pattern by the ink-jet printer shown in FIG. 1;

FIGS. 4A-4C are views each showing one example of a test pattern recorded according to the flow-chart shown in FIG. 3;

FIG. 5 is a functional block diagram of a controller of an ink-jet printer as a second embodiment; and

FIG. 6 is a flow-chart showing a print operation for recording a test pattern by the ink-jet printer shown in FIG. 5.

### BRIEF DESCRIPTION OF THE DRAWINGS

The objects, features, advantages, and technical and industrial significance of the present invention will be better understood by reading the following detailed description of the embodiments of the invention, when considered in connection with the accompanying drawings, in which:

### First Embodiment

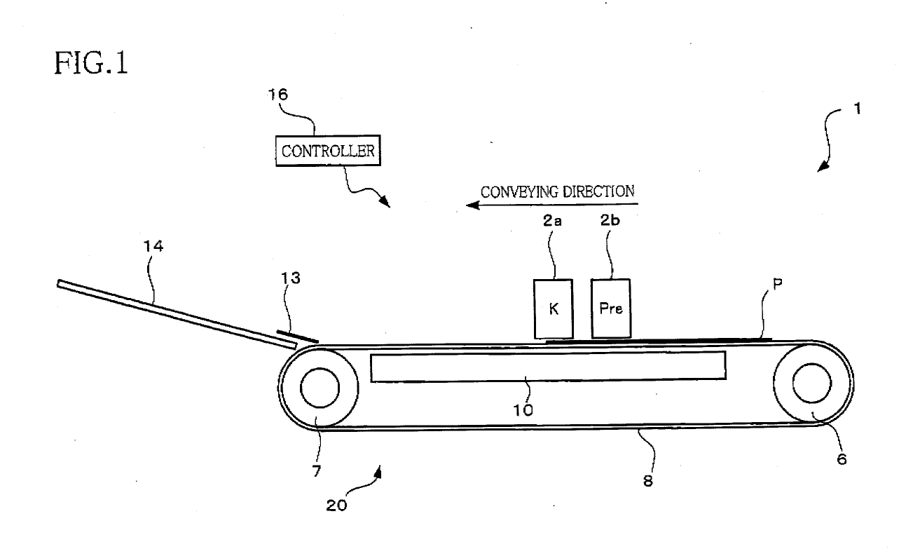

As shown in. FIG. 1, an ink-jet printer 1 includes a conveyor mechanism 20, an ink head 2a (as one example of a first-liquid ejection head), a precoat head 2b (as one example of a second-liquid ejection head), and a controller 16. The ink head 2a has ejection openings formed therein for ejecting droplets of black ink (K) (as one example of first liquid) onto a recording medium in the form of a sheet P conveyed by the conveyor mechanism 20. The precoat head 2b has ejection openings formed therein for ejecting droplets of precoat liquid (Pre) (as one example of second liquid) that coagulates or precipitates a coloring agent of the ink,

In the conveyor mechanism 20, belt rollers 6, 7 are rotated to rotate a conveyor belt 8, whereby the sheet P placed on the conveyor belt 8 is conveyed through positions between the heads 2a, 2b and a platen 10. When the sheet P is conveyed through a position just under the precoat head 2b, the precoat head 2b ejects droplets of the precoat liquid so as to apply the precoat liquid on areas on which an image is to be formed on an upper face of the sheet P. Then, when the sheet P is conveyed through a position just under the ink head 2a, the ink head 2a ejects the ink droplets onto the areas on which the precoat liquid has been applied on the upper face of the sheet P. As a result, a desired image is formed on the sheet P. When the ink droplet is landed on the precoat liquid on the sheet P, the precoat liquid acts on the ink droplet and coagulates or precipitates the coloring agent of the ink droplet, thereby preventing ink spreading on the sheet P Precoat liquid for coagulating pigments is used for pigment ink, and precoat liquid for precipitating dyes is used for dye ink. The precoat liquid may be any suitable liquid such as liquid containing a cationic high polymer and/or polyvalent metal salt such as magnesium salt. When the ink is landed on the area on the sheet P on which the precoat liquid has been applied, the polyvalent metal salt or the like coagulates or precipitates the dyes or the pigments as the coloring agent of the ink, thereby forming an insoluble or hardly soluble metal complex and so on. As a result, a degree of penetration of the landed ink into the sheet P is lowered, which facilitates fixing the ink on the sheet P. The sheet P on which the image has been recorded is peeled from the conveyor belt 8 by a peeling plate 13 and discharged onto a sheet-discharge portion 14.

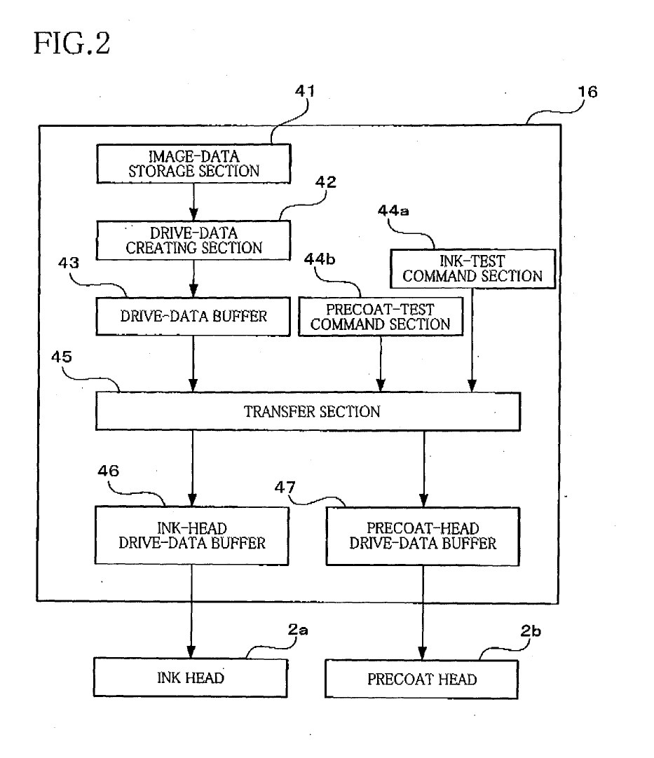

There will be next explained the controller 16 with reference to FIG. 2. As shown in FIG. 2, the controller 16 includes various functional sections such as an image-data storage section 41 as one example of a recording-data storage device, a drive-data creating section 42, a drive-data buffer 43, an ink-test command section 44a, a precoat-test command section 44b, a transfer section 45 as one example of an output controller, an ink-head drive-data buffer 46, and a precoat-head drive-data buffer 47. The controller 16 further includes: a central processing unit (CPU); an electrically erasable and programmable read only memory (EEPROM) rewritably storing therein programs to be executed by the CPU and data used for these programs; and a random access memory (RAM) temporarily storing therein data upon execution of the programs. These various functional sections are constituted by cooperation of these hardware and software in the EEPROM with each other. These programs are stored in various recording media such as a flexible disc, a CD-ROM, and a memory card, and installed into the EEPROM from these recording media. It is noted that the control programs stored in the recording media may be executed directly by the CPU and may be programs that become executable by being installed into the EEPROM. Further, the control programs may be encrypted and/or compressed.

The image-data storage section 41 stores one or more image data (recording data) transmitted from an external device and received together with a print command. This image data contains a gray level value (one of 0-255, for example) for each of a plurality of pixels arranged in matrix.

The drive-data creating section 42 is configured, based on the image data stored in the image-data storage section 41, to create drive data for driving the heads 2a, 2b to form a dot in each pixel. The drive-data buffer 43 is configured to temporarily store the drive data created by the drive-data creating section 42. It is noted that, in the present embodiment, the drive-data creating section 42 creates the drive data in a state in which the image data is completely stored in the image-data storage section 41, but the drive-data creating section 42 may start to create the drive data in a state in which the image data is partly stored in the image-data storage section 41.

The ink-test command section 44a is configured to command printing of an ink test pattern in response to a test-pattern print command transmitted from an external device. The ink test pattern is used for a calibration of the ink head 2a. The precoat-test command section 44b is configured to command printing of a precoat test pattern in response to the test-pattern print command transmitted from the external device. The precoat test pattern is used for a calibration of the precoat head 2b. The print command outputted from the ink-test command section 44a for printing the ink test pattern and the print command outputted from the precoat-test command section 44b for printing the precoat test pattern are not executed at the same time. That is, when the ink-test command section 44a and the precoat-test command section 44b simultaneously output the print command for printing the ink test pattern and the print command for printing the precoat test pattern, respectively, one of the print commands is executed first, and the other print command waits until the execution of the one print command is finished.

The transfer section 45 includes a multiplexer and, based on a presence or absence of the commands outputted from the ink-test command section 44a and/or the precoat-test command section 44b, transfers the drive data temporarily stored in the drive-data buffer 43 selectively to at least one of the ink-head drive-data buffer 46 and the precoat-head drive-data buffer 47. Specifically, when neither the ink-test command section 44a nor the precoat-test command section 44b outputs the print command for printing the test pattern, that is, when the normal recording is performed, the transfer section 45 transfers the drive data temporarily stored in the drive-data buffer 43 to the ink-head drive-data buffer 46 and the precoat-head drive-data buffer 47 in parallel.

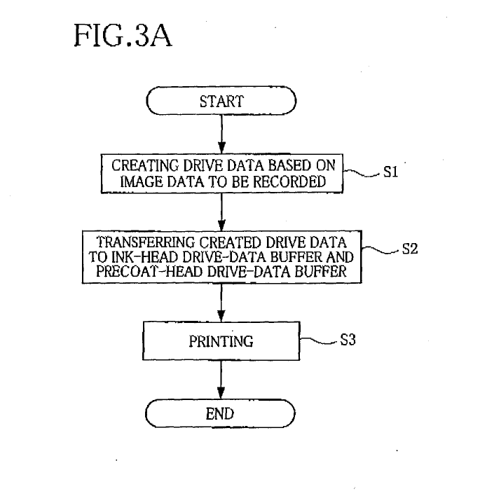

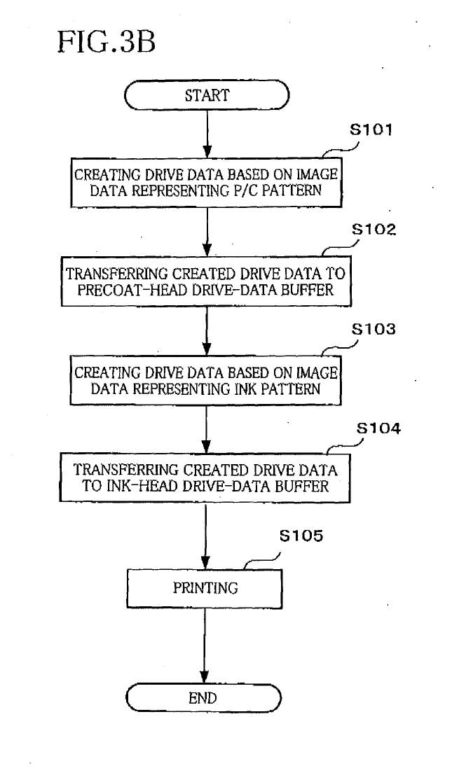

There will be next explained the print operation of the ink-jet printer 1 with reference to FIG. 3A. As shown in FIG. 3A, when the print command is transmitted from the external device to the ink-jet printer 1, that is, when the print command (a normal print command) is transmitted from the external device for printing an image such as a document desired by the user, image data representative of the image desired by the user (hereinafter may be referred to as “image data representative of the image to be recorded”) is stored into the image-data storage section 41. In S1, the drive-data creating section 42 creates the drive data based on the image data stored in the image-data storage section 41 which is representative of the image to be recorded. The created drive data is temporarily stored into the drive-data buffer 43. Then in S2, the transfer section 45 transfers the drive data temporarily stored in the drive-data buffer 43, to both of the ink-head drive-data buffer 46 and the precoat-head drive-data buffer 47. Then in S3, the precoat head 2b ejects the precoat liquid onto the sheet P, and then the ink head 2a ejects liquid droplets of the ink, so that the liquid droplets of the ink are landed on areas on which the precoat liquid has been applied.

When the ink-test command section 44a outputs the print command for printing the ink test pattern, the transfer section 45 transfers the drive data temporarily stored in the drive-data buffer 43 only to the ink-head drive-data buffer 46. When the precoat-test command section 44b outputs the print command for printing the precoat test pattern, the transfer section 45 transfers the drive data temporarily stored in the drive-data buffer 43 only to the precoat-head drive-data buffer 47.

The ink-head drive-data buffer 46 is configured to output the drive data transferred to the transfer section 45, to the ink head 2a. The ink head 2a ejects the ink droplets based on this outputted drive data. The precoat-head drive-data buffer 47 is configured to output the drive data transferred to the transfer section 45, to the precoat head 2b. The precoat head 2b ejects the precoat liquid based on this outputted drive data.

As described above, in the case of the normal recording, the drive data created based on the image data is outputted to both of the ink head 2a and the precoat head 2b. Thus, the liquid droplets of the ink are landed on the areas on which the precoat liquid has been applied. On the other hand, in the case of the recording of the test pattern, the drive data representative of the precoat test pattern is outputted only to the precoat head 2b, and the drive data representative of the ink test pattern is outputted only to the ink head 2a. Thus, the precoat test pattern and the ink test pattern do not overlap each other on the sheet P.

There will be next explained a print operation of the ink-jet printer 1 for printing the test pattern with reference to FIG. 3B. As shown in FIG. 3B, when the print command for printing the test pattern is received from the external device, the image data representative of the test pattern is stored into the image-data storage section 41. The image data stored in the image-data storage section 41 includes: image data representative of the precoat (P/C) test pattern formed of the precoat liquid as one example of the test pattern; and image data representative of the ink test pattern formed of the ink as another example of the test pattern. In S101, the drive-data creating section 42 creates the drive data based on the image data representative of the precoat test pattern stored in the image-data storage section 41. The created drive data is temporarily stored into the drive-data buffer 43. The precoat-test command section 44b commands the printing of the precoat test pattern. In response to this command, the transfer section 45 in S102 transfers the drive data temporarily stored in the drive-data buffer 43 only to the precoat-head drive-data buffer 47. It is noted that since the image data stored in the image-data storage section 41 is stored in response to the print command for printing the test pattern, where the command for printing the test pattern is for printing only the precoat (P/C) test pattern of the precoat liquid, only the image data representative of the precoat (P/C) test pattern of the precoat liquid is included in the image data stored in the image-data storage section 41. Likewise, where the command for printing the test pattern is for printing only the ink test pattern, only the image data representative of the ink test pattern is included in the image data stored in the image-data storage section 41,

In S103, the drive-data creating section 42 creates the drive data based on the image data representative of the ink test pattern stored in the image-data storage section 41. The created drive data is temporarily stored into the drive-data buffer 43. The ink-test command section 44a commands the printing of the ink test pattern. In response to this command, the transfer section 45 in S104 transfers the drive data temporarily stored in the drive-data buffer 43 only to the ink-head drive-data buffer 46.

In S105, in order to record a predetermined test pattern on the sheet P, the drive data transferred to the precoat-head drive-data buffer 47 is outputted to the precoat head 2b, and the drive data transferred to the ink-head drive-data buffer 46 is outputted to the ink head 2a. The test pattern including the precoat test pattern and the ink test pattern is recorded on the sheet P, and the processing shown in FIG. 3B is finished.

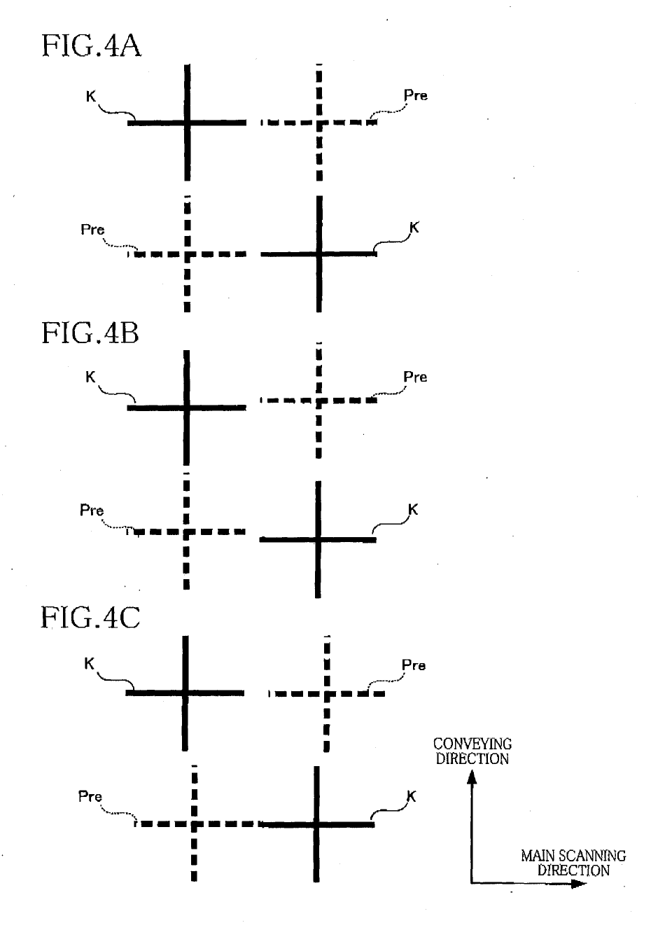

There will be next explained one example of the test pattern recorded according to the above-described processing with reference to FIGS. 4A-4C. In FIGS. 4A-4C, cross marks drawn in solid lines indicate the ink test patterns, and cross marks drawn in broken lines indicate the precoat test patterns. It is noted that the precoat test pattern is colorless but can be visually recognized by a user using a specific light or camera. As shown in FIG. 4A, in this test pattern, the ink test patterns and the precoat test patterns are alternately arranged in both of a conveying direction in which the sheet P is conveyed and a main scanning direction that is perpendicular to the conveying direction. In a test (examination) processing of the ink-jet printer 1, a registration is performed using the recorded test pattern to adjust a displacement between a position at which the ink is ejected and a position at which the precoat liquid is ejected. There will be explained one example of the registration.

FIG. 4A shows the test pattern in the case where the registration has been completed. In a case where there is displacement between ejection timings of the ink head 2a and the precoat head 2b, even if the recording operation is performed such that the test pattern shown in FIG. 4A is to be formed, each of the ink test patterns and a corresponding one of the precoat test patterns, as shown in FIG. 4B, are displaced from each other in the conveying direction in the recorded test pattern. In a case where there is displacement between fixed positions of the ink head 2a and the precoat head 2b in the main scanning direction, even if the recording operation is performed such that the test pattern shown in FIG. 4A is to be formed, each of the ink test patterns and a corresponding one of the precoat test patterns, as shown in FIG. 4C, are displaced from each other in the main scanning direction in the recorded test pattern. The registration is completed by adjusting the ejection timings and the fixed positions of the heads 2a, 2b such that the test pattern shown in FIG. 4A is to be recorded in which each of the ink test patterns and a corresponding one of the precoat test patterns are aligned to each other in the conveying direction and the main scanning direction. It is noted that only the ejection timing and the fixed position of the precoat head 2b may be adjusted using the ink head 2a as a reference, and alternatively, only the ejection timing and the fixed position of the ink head. 2a may be adjusted using the precoat head 2b as a reference.

In the ink-jet printer 1 as the present embodiment, the image data (the drive data) is selectively supplied to at least one of the ink head 2a and the precoat head 2b, and when the precoat test pattern is recorded on the sheet P, the drive data representative of the precoat test pattern is outputted only to the precoat head 2b without being outputted to the ink head 2a. Thus, the precoat test pattern can be recorded without overlapping the ink. Further, when the ink test pattern is recorded on the sheet P, the drive data representative of the ink test pattern is outputted only to the ink head 2a without being outputted to the precoat head 2b. Thus, the ink test pattern can be recorded without overlapping the precoat liquid.

Further, since the ink-head drive-data buffer 46 and the precoat-head drive-data buffer 47 are provided, it is easy to design a configuration in which the drive data representative of the precoat test pattern is outputted only to the precoat head 2b. Moreover, different drive data can be easily outputted to the ink head 2a and the precoat head 2b, respectively.

Further, since the transfer section 45 includes the multiplexer, these configurations can be easily designed.

### Second Embodiment

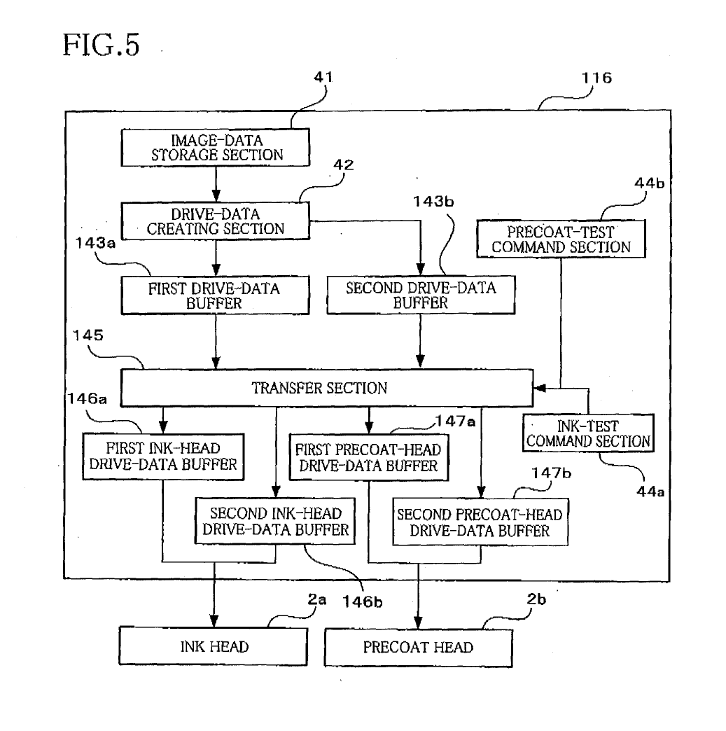

There will be next explained a second embodiment of the present invention. It is noted that the same reference numerals as used in the first embodiment are used to designate the corresponding elements of the second embodiment, and an explanation of which is dispensed with. As shown in FIG. 5, a controller 116 includes, as functional sections, the image-data storage section 41, the drive-data creating section 42, a first drive-data buffer 143a, a second drive-data buffer 143b, the ink-test command section 44a, the precoat-test command section 44b, a transfer section 145, a first ink-head drive-data buffer 146a, a second ink-head drive-data buffer 146b, a first precoat-head drive-data buffer 147a, and a second precoat-head drive-data buffer 147b.

The first drive-data buffer 143a and the second drive-data buffer 143b temporarily stores the drive data stored in and transmitted from the drive-data creating section 42 in order.

The transfer section 145, based on the commands outputted from the ink-test command section 44a and/or the precoat-test command section 44b, transfers the drive data temporarily stored in the first and second drive-data buffers 143a, 143b selectively to one or ones of the first and second ink-head drive-data buffers 146a, 146b and the first and second precoat-head drive-data buffers 147a, 147b. Specifically, when neither the ink-test command section 44a nor the precoat-test command section 44b outputs the print command for printing the test pattern, that is, when the normal recording is performed, the transfer section 145 transfers the drive data temporarily stored in the first drive-data buffer 143a to the first ink-head drive-data buffer 146a and the first precoat-head drive-data buffer 147a and transfers the drive data temporarily stored in the second drive-data buffer 143b to the second ink-head drive-data buffer 146b and the second precoat-head drive-data buffer 147b in parallel in the order in which the data are temporarily stored. Alternatively, the transfer section 145 transfers the drive data temporarily stored in the first drive-data buffer 143a to the second ink-head drive-data buffer 146b and the second precoat-head drive-data buffer 147b and transfers the drive data temporarily stored in the second drive-data buffer 143b to the first ink-head drive-data buffer 146a and the first precoat-head drive-data buffer 147a in parallel in the order in which the data are temporarily stored.

When the ink-test command section 44a outputs the print command for printing the ink test pattern, the transfer section 145 transfers the drive data temporarily stored in the first drive-data buffer 143a, only to the first ink-head drive-data buffer 146a. Further, when the precoat-test command section 44b outputs the print command for printing the precoat test pattern, the transfer section 145 transfers the drive data temporarily stored in the second drive-data buffer 143b, only to the second precoat-head drive-data buffer 147b.

The first and second ink-head drive-data buffers 146a, 146b output the drive data transferred to the transfer section 145, to the ink head 2a in the order in which the drive data are transferred. The first and second precoat-head drive-data buffers 147a, 147b output the drive data transferred to the transfer section 145, to the precoat head 2b in the order in which the drive data are transferred. Here, the first ink-head drive-data buffer 146a and the first precoat-head drive-data buffer 147a output the drive data respectively to the ink head 2a and the precoat head 2b such that the precoat head 2b and the ink head 2a respectively eject the precoat liquid and the ink to the same positions on the recording medium, and the second ink-head drive-data buffer 146b and the second precoat-head drive-data buffer 147b output the drive data respectively to the ink head 2a and the precoat head 2b such that the precoat head 2b and the ink head 2a respectively eject the precoat liquid and the ink to the same positions on the recording medium.

As described above, in the case of the normal recording, the drive data created based on the image data is outputted from the first ink-head drive-data buffer 146a and the first precoat-head drive-data buffer 147a, or the second ink-head drive-data buffer 146b and the second precoat-head drive-data buffer 147b to both of the ink head 2a and the precoat head 2b. Thus, the liquid droplets of the ink are landed on the areas on which the precoat liquid has been applied. On the other hand, in the case of the recording of the test pattern, the drive data representative of the precoat test pattern is outputted from the second precoat-head drive-data buffer 147b only to the precoat head 2b, and the drive data representative of the ink test pattern is outputted from the first ink-head drive-data buffer 146a only to the ink head 2a. Thus, the precoat test pattern and the ink test pattern do not overlap each other.

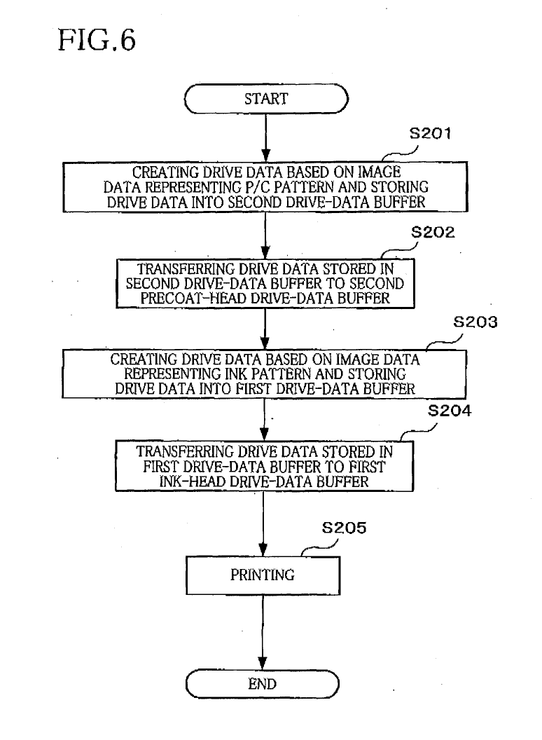

There will be next explained a print operation of the ink-jet printer as the present embodiment for printing the test pattern with reference to FIG. 6. As shown in FIG. 6, when, the print command for printing the test pattern is received from the external device, the drive-data creating section 42 in S201 converts the image data representative of the precoat test pattern stored in the image-data storage section 41, to the drive data The converted drive data is temporarily stored into the second drive-data buffer 143b. Then in S202, the transfer section 145 transfers the drive data temporarily stored in the second drive-data buffer 143b, only to the second precoat-head drive-data buffer 147b.

In S203, the drive-data creating section 42 creates the drive data from the image data representative of the ink test pattern stored in the image-data storage section 41. The created drive data is temporarily stored into the first drive-data buffer 143a. In S204, the transfer section 145 transfers the drive data temporarily stored in the first drive-data buffer 143 a, only to the first ink-head drive-data buffer 146a.

Then in S205, the drive data transferred to the second precoat-head drive-data buffer 147b is outputted to the precoat head 2b, and the drive data transferred to the first ink-head drive-data buffer 146a is outputted to the ink head 2a to record the predetermined test pattern on the sheet P. As a result, the test pattern including the precoat test pattern and the ink test pattern is recorded on the sheet P, and the processing shown in FIG. 6 is finished.

In the ink-jet printer as the present embodiment, the image data (the drive data) is selectively supplied to at least one of the ink head 2a and the precoat head 2b, and when the precoat test pattern is recorded on the sheet P, the drive data representative of the precoat test pattern is outputted only to the precoat head 2b without being outputted to the ink head 2a. Thus, the precoat test pattern can be recorded without overlapping the ink. Further, when the ink test pattern is recorded on the sheet P, the drive data representative of the ink test pattern is outputted only to the ink head 2a without being outputted to the precoat head 2b. Thus, the ink test pattern can be recorded without overlapping the precoat liquid

Further, two image data (two sets of the image data) can be processed in parallel by the first drive-data buffer 143a, the second drive-data buffer 143b, the first ink-head drive-data buffer 146a, the second ink-head drive-data buffer 146b, the first precoat-head drive-data buffer 147a, the second precoat-head drive-data buffer 147b, and the transfer section 145. Thus, the plurality of the image data can be processed at the same time in the normal recording that is performed when the print command for printing the test pattern is not outputted. Further, when the print command for printing the test pattern is outputted, the different drive data can speedily outputted to the ink head 2a and the precoat head 2b, respectively.

While the embodiments of the present invention have been described above, it is to be understood that the invention is not limited to the details of the illustrated embodiments, but may be embodied with various changes and modifications, which may occur to those skilled in the art, without departing from the spirit and scope of the invention. For example, in the above-described embodiments, the precoat liquid is not ejected when the ink test pattern is recorded on the sheet P, but the precoat liquid may also be ejected when the ink test pattern is recorded on the sheet P. It is noted that the precoat liquid is colorless and transparent, and thus even if the precoat liquid contacts or overlaps the ink, the ink test pattern can be used as in the above-described embodiments without loss of its function.

In the above-described embodiments, the ink-head drive-data buffer 46 and the precoat-head drive-data buffer 47 are provided, but the drive data may be directly outputted to the heads without providing these buffers.

In the above-described embodiments, the drive data representative of the precoat test pattern is outputted in response to the print command for printing the precoat test pattern by the precoat-test command section 44b, but not only the drive data representative of the precoat test pattern but also the drive data representative of the ink test pattern may be outputted in response to the print command for printing the precoat test pattern by the precoat-test command section 44b.

In the above-described embodiments, the transfer section includes the multiplexer, but a configuration of the hardware is not limited to this one.

In the above-described embodiments, the precoat test pattern and the ink test pattern are recorded on one sheet, but the print command for printing the precoat test pattern and the print command for printing the ink test pattern may be judged based on the print commands in the units of the sheets. Alternatively, the print command for printing the precoat test pattern and the print command for printing the ink test pattern may be judged in units of any areas on the sheet.

Further, in the above-described second embodiment, when the ink-test command section 44a outputs the print command for printing the ink test pattern, the transfer section 145 transfers the drive data temporarily stored in the first drive-data buffer 143a, only to the first ink-head drive-data buffer 146a, and when the precoat-test command section 44b outputs the print command for printing the precoat test pattern, the transfer section 145 transfers the drive data temporarily stored in the second drive-data buffer 143b, only to the second precoat-head drive-data buffer 147b. However, the transfer section 145 may, when the ink-test command section 44a outputs the print command for printing the ink test pattern, transfer the drive data temporarily stored in the first drive-data buffer 143a, only to the second ink-head drive-data buffer 146b, and when the precoat-test command section 44b outputs the print command for printing the precoat test pattern, transfer the drive data temporarily stored in the second drive-data buffer 143b, only to the first precoat-head drive-data buffer 147a.

In the above-described embodiments, the single CPU of the controller 16 (116) executes all the processings. However, the present invention is not limited to this configuration. For example, the controller 16 (116) may use a plurality of CPUs, an application-specific integrated circuit (ASIC), or a combination of the CPU(s) and the ASIC to execute the processings explained above.

While the precoat liquid is used as the second liquid in the above-described embodiments, a post-treatment liquid (post-coat liquid) may be used as the second liquid. In such a case, a second-liquid ejection head for ejecting the post-coat liquid is disposed downstream of the first-liquid ejection head in the conveying direction.

The present invention is applicable to a liquid ejection apparatus configured to eject liquid other than the ink. The present invention is applicable not only to the printer but also to various devices for image recording such as a facsimile machine and a copying machine.

What is claimed is:

1. An image recording apparatus, comprising:
a conveyor mechanism configured to convey a recording medium in a conveying direction;
a first-liquid ejection head having at least one first ejection opening, the first-liquid ejection head configured to eject first liquid for recording an image on the recording medium through the first ejection opening;
a second-liquid ejection head having at least one second ejection opening, the second-liquid ejection head configured to eject transparent liquid as second liquid through the second ejection opening;
a recording-data storage device configured to store therein recording data representative of one of an image to be recorded and an image of a test pattern of the second liquid;
a second-liquid test-pattern recording command section configured to command recording of the test pattern of the second liquid on the recording medium; and
an output controller configured to output the recording data selectively to at least one of the first-liquid ejection head and the second-liquid ejection head,
the output controller configured to:
output the recording data representative of the image to be recorded, to the first-liquid ejection head and the second-liquid ejection head when the second-liquid test-pattern recording command section does not command the recording of the test pattern of the second liquid; and
output the recording data representative of the test pattern of the second liquid, not to the first-liquid ejection head but to the second-liquid ejection head when the second-liquid test-pattern recording command section commands the recording of the test pattern of the second liquid.

2. The image recording apparatus according to claim 1,
wherein the second-liquid ejection head is provided upstream of the first-liquid ejection head in the conveying direction, and
wherein the second liquid is liquid for coagulating or precipitating a constituent of the first liquid.

3. The image recording apparatus according to claim 1, further comprising:
a first output buffer configured to store the recording data outputted from the output controller and to be supplied to the first-liquid ejection head; and
a second output buffer configured to store the recording data outputted from the output controller and to be supplied to the second-liquid ejection head,
wherein, when the second-liquid test-pattern recording command section does not command the recording of the test pattern of the second liquid, the output controller outputs the recording data representative of the image to be recorded, to the first output buffer and the second output buffer, and
wherein, when the second-liquid test-pattern recording command section commands the recording of the test pattern of the second liquid, the output controller outputs the recording data representative of the test pattern of the second liquid, not to the first output buffer but to the second output buffer.

4. The image recording apparatus according to claim 3,
wherein, when the second-liquid test-pattern recording command section does not command the recording of the test pattern of the second liquid, the output controller outputs the recording data representative of the image to be recorded, to the first output buffer and the second output buffer, and
wherein, when the second-liquid test-pattern recording command section commands the recording of the test pattern of the second liquid, the output controller outputs the recording data representative of the test pattern of the second liquid, to the second output buffer and outputs recording data representative of a test pattern of the first liquid, to the first output buffer.

5. The image recording apparatus according to claim 3, further comprising:
a third output buffer configured to store the recording data outputted from the output controller and to be supplied to the first-liquid ejection head; and
a fourth output buffer configured to store the recording data outputted from the output controller and to be supplied to the second-liquid ejection head,
wherein, when the second-liquid test-pattern recording command section does not command the recording of the test pattern of the second liquid, the output controller outputs the recording data representative of the image to be recorded, to the first output buffer and the second output buffer or to the third output buffer and the fourth output buffer, and
wherein, when the second-liquid test-pattern recording command section commands the recording of the test pattern of the second liquid, the output controller outputs recording data representative of a test pattern of the first liquid, to the first output buffer and outputs the recording data representative of the test pattern of the second liquid, to the fourth output buffer.

6. The image recording apparatus according to claim 3, wherein the output controller includes a multiplexer.

7. The image recording apparatus according to claim 1, further comprising a first-liquid test-pattern recording command section configured to command recording of a test pattern of the first liquid on the recording medium,
wherein the recording-data storage device is configured to further store recording data representative of an image of the test pattern of the first liquid,
wherein, when the first-liquid test-pattern recording command section does not command the recording of the test pattern of the first liquid, and the second-liquid test-pattern recording command section does not command the recording of the test pattern of the second liquid, the output controller outputs the recording data representative of the image to be recorded, to the first-liquid ejection head and the second-liquid ejection head, and
wherein, when the first-liquid test-pattern recording command section commands the recording of the test pattern of the first liquid, the output controller outputs the recording data representative of the test pattern of the first liquid, not to the second-liquid ejection head but to the first-liquid ejection head.

8. An image recording apparatus, comprising:
a conveyor mechanism configured to convey a recording medium in a conveying direction;
a first-liquid ejection head having at least one first ejection opening, the first-liquid ejection head configured to eject first liquid for recording an image on the recording medium through the first ejection opening;
a second-liquid ejection head having at least one second ejection opening, the second-liquid ejection head configured to eject transparent liquid as second liquid through the second ejection opening;
a recording-data storage device configured to store therein recording data representative of one of an image to be recorded and an image of a test pattern of the second liquid; and
an output controller configured to output the recording data selectively to at least one of the first-liquid ejection head and the second-liquid ejection head,
wherein the recording data representative of the image to be recorded corresponds to an image recording command that is a command for recording the image to be recorded, on the recording medium, and
wherein the recording data representative of the image of the test pattern of the second liquid corresponds to a test-pattern recording command that is a command for recording the image of the test pattern of the second liquid on the recording medium,
the output controller configured to:
output the recording data representative of the image to be recorded, to the first-liquid ejection head and the second-liquid ejection head when the image recording command is outputted; and
output the recording data representative of the test pattern of the second liquid, not to the first-liquid ejection head but to the second-liquid ejection head when the test-pattern recording command is outputted.

9. The image recording apparatus according to claim 8,
wherein the second-liquid ejection head is provided upstream of the first-liquid ejection head in the conveying direction, and
wherein the second liquid is liquid for coagulating or precipitating a constituent of the first liquid.

10. The image recording apparatus according to claim 8, further comprising a drive-data creating section configured to create drive data for driving at least one of the fast-liquid ejection head and the second-liquid ejection head based on the recording data stored in the recording-data storage device,
wherein, when the image recording command is outputted, the drive-data creating section creates the drive data based on the recording data representative of the image to be recorded,
wherein, when the test-pattern recording command is outputted, the drive-data creating section creates the drive data based on the recording data representative of the image of the test pattern of the second liquid,
wherein, when the image recording command is outputted, the output controller outputs the drive data created by the drive-data creating section, to the first-liquid ejection head and the second-liquid ejection head, and
wherein, when the test-pattern recording command is outputted, the output controller outputs the drive data created by the drive-data creating section, not to the first-liquid ejection head but to the second-liquid ejection head.

11. The image recording apparatus according to claim 8, further comprising a drive-data creating section configured to create drive data for driving at least one of the first-liquid ejection head and the second-liquid ejection head based on the recording data stored in the recording-data storage device,
wherein the recording-data storage device is configured to further store recording data representative of an image of the test pattern of the first liquid,
wherein, when the image recording command is outputted, the drive-data creating section creates the drive data based on the recording data representative of the image to be recorded,
wherein, when the test-pattern recording command is outputted, the drive-data creating section creates the drive data for the first-liquid ejection head based on the recording data representative of the image of the test pattern of the first liquid and creates the drive data for the second-liquid ejection head based on the recording data representative of the image of the test pattern of the second liquid,
wherein, when the image recording command is outputted, the output controller outputs the drive data created by the drive-data creating section, to the first-liquid ejection head and the second-liquid ejection head, and
wherein, when the test-pattern recording command is outputted, the output controller outputs the drive data created by the drive-data creating section for the first-liquid ejection head, to the first-liquid ejection head and outputs the drive data created by the drive-data creating section for the second-liquid ejection head, to the second-liquid ejection head.

12. A nontransitory storage medium storing a program to be executed by a computer of an image recording apparatus, the image recording apparatus comprising:
a conveyor mechanism configured to convey a recording medium in a conveying direction;
a first-liquid ejection head having at least one first ejection opening, the first-liquid ejection head configured to eject first liquid for recording an image on the recording medium through the first ejection opening;
a second-liquid ejection head having at least one second ejection opening, the second-liquid ejection head configured to eject transparent liquid as second liquid through the second ejection opening; and
a recording-data storage device configured to store therein recording data representative of one of an image to be recorded and an image of a test pattern of the second liquid, the program designed to have the computer function as:
a second-liquid test-pattern recording command section configured to command recording of the test pattern of the second liquid on the recording medium; and
an output controller configured to output the recording data selectively to at least one of the first-liquid ejection head and the second-liquid ejection head,
the output controller configured to:
output the recording data representative of the image to be recorded, to the first-liquid ejection head and the second-liquid ejection head when the second-liquid test-pattern recording command section does not command the recording of the test pattern of the second liquid; and
output the recording data representative of the test pattern of the second liquid, not to the first-liquid ejection head but to the second-liquid ejection head when the second-liquid test-pattern recording command section commands the recording of the test pattern of the second liquid.
